(19) United States
(12) Patent Application Publication
(10) Pub. No.: US 2008/0320046 A1
(43) Pub. Date: Dec. 25, 2008

(54) VIDEO DATA MANAGEMENT APPARATUS

(76) Inventors: Akihiro WATABE, Nara (JP); Yuichiro Aihara, Osaka (JP)

Correspondence Address: MCDERMOTT WILL & EMERY LLP, 600 13TH STREET, NW, WASHINGTON, DC, 20005-3096, US

(21) Appl. No.: 12/100,315

(22) Filed: Apr. 9, 2008

(30) Foreign Application Priority Data
Jun. 20, 2007 (JP) 2007-162776

(51) Int. Cl. G06F 3/048; G06F 17/30

(52) U.S. Cl. 707/104.1; 715/764; 715/835; 707/E17.009

(57) ABSTRACT

Feature amount information of video data in a hard disk is calculated by a decoder and a feature amount extraction section. An icon reflecting the feature amount information is generated by an icon generation section and is presented to the user. A feature amount index control section pairs the feature amount information received from the feature amount extraction section with a position in the hard disk of the video data, and records the pair as index information, so that the speed of image retrieval is improved.

### BACKGROUND OF THE INVENTION

1. Field of the Invention

The present invention relates to an apparatus for managing video data including a moving image and, more particularly, to a retrieval apparatus, a reproduction apparatus, a recording apparatus, and the like that utilize a feature or a pattern of video data.

2. Description of the Related Art

Conventionally, research has been conducted in the field of information retrieval. In particular, considerably high-accuracy retrieval has been achieved for text data. Similarly, for moving images or still images, services in which retrieval is performed using an input keyword have been provided. For example, a technique that utilizes meta-data of a moving image during retrieval has been proposed (Japanese Unexamined Patent Application Publication No. 2007-12013).

However, an appropriate keyword is not always assigned to video data. Also, if moving image data, photograph data, or the like is privately recorded by the user, keyword search cannot be performed with respect to the data unless a keyword is previously associated with the data by the user itself.

On the other hand, image recognition technology has been advanced, and a technique of analyzing a feature or a pattern of an image and classifying or searching for video data has been conventionally studied (see U.S. Pat. No. 6,665,442). Also, a technique of creating a retrieval menu having good retrieval efficiency using various categorization patterns is known (see U.S. Pat. No. 6,219,665).

In recent years, video data recorders having large-capacity hard disks are becoming widespread. For such recorders, efficient retrieval of video data stored in the hard disk is required.

However, time and efforts are particularly required for the conventional technique of associating keywords with privately recorded moving images or still images. Also, the classification technique using features or patterns of images is supposed to be used by experts or the like. It has not been taken into consideration that an easily recognizable classification reference is presented to general users.

### SUMMARY OF THE INVENTION

To solve the above-described problem, the present invention provides to the user an intuitive interface by generating icons that are representative samples matching the results of analysis of feature amounts or patterns.

As described above, the recent increase in the hard disk capacity leads to a demand for a function of easily retrieving a desired moving image or still image. Recent DVD (Digital Versatile Disc) recorders have a function of linking to a digital camera, so that retrieval of a still image is also an important function. The types of video widely include TV broadcast video, video downloaded from a network, video recorded by the user, and the like. The encoding format varies among them, and there is no standard format for retrieval. In such a situation, it would be considerably convenient to actually recognize features of moving images or still images, and retrieve, for example, a specific human face or a specific sport.

With the state-of-the-art image recognition technology, these images can be recognized to some extent within a limit. For example, sports that are performed on lawn often have features, such as intense motions and a green background. News broadcasts have a feature such that someone is present behind a desk.

Data recorded by the user is typically biased, so that general categorization is not helpful. It is also considered that retrieval of data recorded by the user is not necessarily perfect, and pattern recognition that provides some guidance is sufficient.

However, it is considerably difficult for the user to input a search pattern, for example, “green background and intense human motion”. The user usually desires to search for a scene based on the content rather than the image feature. It is difficult to involve the user in such pattern recognition.

Therefore, a main object of the present invention is to explicitly present the user a pattern that is actually extracted from video data, in an easily recognizable manner. To achieve this object, an icon reflecting a feature amount of a moving image or a still image is presented to the user.

This icon is not a smaller version of an image (i.e., so-called thumbnail), and clearly represents a feature amount pattern and is dynamically generated, depending on a content to be retrieved. The icon also provides a visible image of retrieval based on a feature amount. This is more universal than thumbnails, and can further emphasize the feature amount pattern. Whereas it is difficult to generate a thumbnail common to a plurality of moving images or still images, such a problem does not arise for icon generation based on the feature amount pattern. These features are significantly advantageous when they are used for retrieval.

According to the present invention, by generating icons from feature amounts of video data, it is possible to create various icons that visually reflect various feature amounts and are easily recognized by the user.

Also, by presenting an icon indicating a feature amount to the user, who in turn selects the icon to perform retrieval using the feature amount, it is possible to achieve retrieval using a feature amount that can be easily imagined by the user.

### BRIEF DESCRIPTION OF THE DRAWINGS

FIG. 1 is a block diagram showing an exemplary configuration of a video data recorder having a data management function according to the present invention.

FIG. 2 is a block diagram showing an exemplary internal configuration of a moving image processing portion of the decoder of FIG. 1.

FIG. 3 is a flowchart showing an operation of an icon generation section of FIG. 1.

FIGS. 4A, 4B and 4C are diagrams showing exemplary background icons.

FIGS. 5A and 5B are diagrams showing an exemplary foreground icon and its exemplary deformation.

FIGS. 6A and 6B are diagrams showing another exemplary foreground icon and its exemplary deformation.

FIGS. 7A and 7B are diagrams showing a still another exemplary foreground icon and its exemplary deformation.

FIGS. 8A and 8B are diagrams showing exemplary foreground icons representing motions.

FIGS. 9A and 9B are diagrams showing other exemplary foreground icons representing motions.

FIGS. 10A and 10B are diagrams showing exemplary audio icons.

FIG. 11 is a diagram showing an exemplary foreground icon representing a variance of motions.

FIG. 12 is a diagram showing an example in which a foreground icon is superimposed on a background icon.

FIG. 13 is a diagram showing an example in which a foreground icon and an audio icon are superimposed on a background icon.

FIG. 14 is a flowchart of video data retrieval in the video data recorder of FIG. 1.

FIG. 15 is a diagram showing an exemplary retrieval menu screen of the video data recorder of FIG. 1.

FIG. 16 is a diagram showing an exemplary normal reproduction screen of the video data recorder 10 of FIG. 1.

FIG. 17 is a diagram showing an exemplary moving image reproduction menu screen of the video data recorder of FIG. 1.

### DETAILED DESCRIPTION OF THE PREFERRED EMBODIMENTS

Hereinafter, embodiments in the best mode of the present invention will be described with reference to the accompanying drawings.

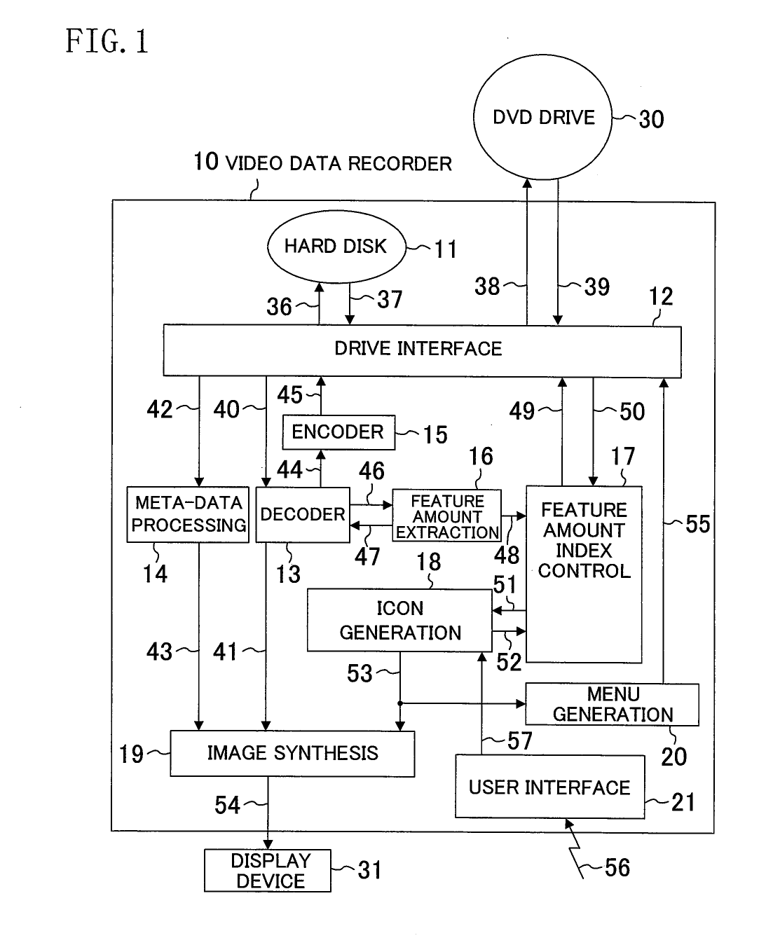

FIG. 1 shows an exemplary configuration of a video data recorder having a data management function according to the present invention. The video data recorder 10 of FIG. 1 comprises a hard disk 11, a drive interface section 12, a decoder 13, a meta-data processing section 14, an encoder 15, a feature amount extraction section 16, a feature amount index control section 17, an icon generation section 18, an image synthesis section 19, a menu generation section 20, and a user interface section 21. A DVD drive 30 and a display device 31 are provided external to the video data recorder 10.

The hard disk 11 stores various types of video data, such as encoded moving image data or still image data (in some cases, audio data or meta-data is included).

The drive interface section 12 gives write data 36 to and receives read data 37 from the hard disk 11. The drive interface section 12 also gives write data 38 to and receives read data 39 from the DVD drive 30.

The decoder 13 decodes video data 40 received from the drive interface section 12. The decoding result is supplied as a decoded image 41 to the image synthesis section 19, and as feature amount extraction image data 46 to the feature amount extraction section 16. The decoder 13 also supplies audio data to the feature amount extraction section 16.

The meta-data processing section 14, for example, receives, from the drive interface section 12, meta-data 42 that is stored together with video data in the hard disk 11, and supplies a keyword 43 assigned to the video data to the image synthesis section 19.

The encoder 15, for example, during dubbing, encodes video data 44 received from the decoder 13, and supplies an encoded image 45 to the drive interface section 12.

The feature amount extraction section 16 extracts various feature amounts from video data 46 received from the decoder 13, and supplies feature amount information 48 to the feature amount index control section 17. As used herein, the feature amount ranges widely from an advanced feature amount for recognizing a specific human face to a feature amount representing only color tendency. The feature amount extraction section 16 also supplies algorithm selection information 47 to the decoder 13 so that an appropriate decoding algorithm is designated in the decoder 13.

The feature amount index control section 17 pairs the feature amount information 48 received from the feature amount extraction section 16 with a position in the hard disk 11 at which video data is stored, and records the pair as index information, and gives feature amount information 51 to and receives selected-feature amount information 52 from the icon generation section 18. If the feature amount extraction section 16 is operated during free time to generate and record index information into the feature amount index control section 17, the speed of image retrieval described below can be increased. For video data whose index information has not yet been generated, the feature amount index control section 17 receives new feature amount information 48 from the feature amount extraction section 16. In this case, index information may be generated and recorded.

The icon generation section 18 generates an icon that is a small image reflecting the feature amount information 51 received from the feature amount index control section 17, and supplies an icon image 53 to the image synthesis section 19 and the menu generation section 20.

The image synthesis section 19 combines the decoded image 41 received from the decoder 13, the keyword 43 received from the meta-data processing section 14, and the icon image 53 received from the icon generation section 18 into a single screen image, and supplies synthesized video data 54 to the display device 31.

The user interface section 21 receives user selection information 56 for icon selection via, for example, a remote controller, and supplies icon selection information 57 to the icon generation section 18.

The selected-feature amount information 52 that is supplied to the feature amount index control section 17 from the icon generation section 18 that has received by the icon selection information 57, is information that indicates the range of a selected feature amount. The feature amount index control section 17 selects video data to be read from the hard disk 11 based on the selected-feature amount information 52, and gives a read command 49 to and receives a response signal 50 from the drive interface section 12.

The menu generation section 20 generates a menu for dubbing using the icon image 53 received from the icon generation section 18, and supplies menu data 55 to the drive interface section 12 so that the menu is written into, for example, a DVD.

The video data recorder 10 of FIG. 1 can perform special reproduction, skipping, and the like in addition to normal reproduction. The video data recorder 10 reads various user commands via the user interface section 21 to perform these functions. The functions are typically displayed in the form of a menu on a screen of the display device 31 and are selected by the user before being performed. Note that the detailed configuration is not shown.

Note that the decoder 13 of FIG. 1 is configured to be used during reproduction of video data as well as during extraction of a feature amount so as to be able to decode all encoded video data in a supported format in real time. Thereby, it is no longer necessary to separately provide a decoder for feature amount extraction and a decoder for normal reproduction, resulting in an advantage in terms of cost. Note that separate dedicated decoders may be prepared.

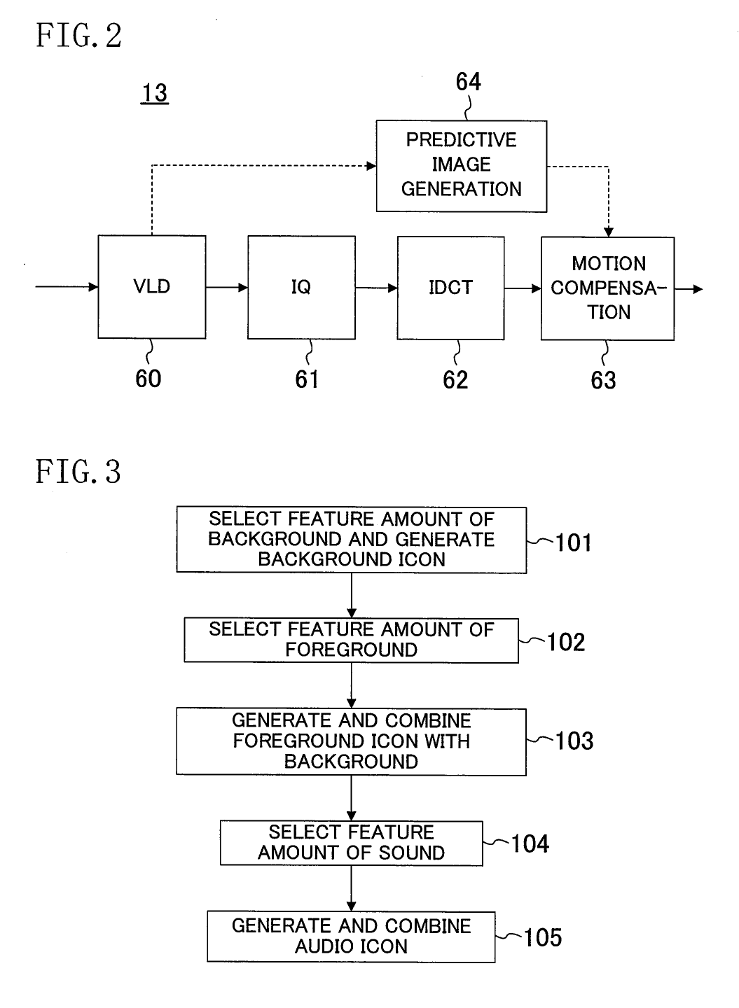

FIG. 2 shows an exemplary internal configuration of a moving image processing portion of the decoder 13 of FIG. 1. It is here assumed that moving image data encoded by the MPEG (Moving Picture Experts Group) standards is handled. The moving image processing portion comprises a VLD (Variable Length Decoding) section 60, an IQ (Inverse Quantization) section 61, an IDCT (Inverse Discrete Cosine Transform) section 62, a motion compensation section 63, and a predictive image generation section 64. Note that, when only I (Intra) picture(s) is decoded for feature amount extraction, a decoding algorithm in which the operation of the predictive image generation section 64 is removed is used so that processing speed can be increased or power consumption can be decreased. A motion vector calculated by the VLD section 60 can be used for extraction of a feature “intensity of a motion” in the feature amount extraction section 16. Also, if the decoder 13 and the feature amount extraction section 16 are separated as shown in FIG. 1, feature amount extraction can be performed irrespective of encoding format.

Note that the feature amount extraction section 16 does not request a perfect decoding function from the decoder 13. A lowest resolution may be sufficient or a very large motion may not be required, depending on the extraction algorithm. In particular, when still images are mainly used for feature amount extraction, it is not necessary to calculate a feature amount in very short time intervals. For example, the decoder 13 can process moving image data as still images that are provided at the rate of one per second.

Next, an operation of the icon generation section 18 that is a basis of the present invention will be described. The purpose of an icon as used herein is to specifically convert information about a feature amount into an image that can be easily imagined by the user. The icon may be a single image, and may represent a feature of a plurality of moving images when it is used for retrieval. In this case, when the feature amount varies, the icon is not very suitable as representation of a feature of a plurality of moving images. Therefore, the icon generation section 18 receives each type of feature amounts and, if a plurality of moving images are present, a variance value as an index indicating the variation, and generates an icon. In other words, the icon generation section 18 receives the type of feature amounts, the values of the feature amounts, and a variance value of the values. The icon types are categorized into one for the background, one for the foreground, and one relating to audio.

Each feature amount is associated with corresponding basic icon data and its deformation type. These pieces of information are desirably recorded in the icon generation section 18. Various methods may be used to associate these pieces of information in the icon generation section 18 with their deformation types, and are implemented by software and are processed by a processor for the purposes of general versatility. In this case, the function can be easily extended by changing software.

FIG. 3 is a flowchart specifically showing an operation of the icon generation section 18 of FIG. 1. In FIG. 3, in step 101, one is selected from feature amounts indicating a background, and a corresponding background icon is generated. The background icon is in the shape of a rectangle and has a relatively large range. The selected feature amount indicating the background desirably has a small variance and a large value. In step 102, some feature amounts are selected from foreground feature amounts with priority. As a criterion for this selection, feature amounts having smaller variances and larger values are desirably selected with priority as in the case of the background. In step 103, foreground icons corresponding to the feature amounts selected in step 102 are successively generated and arranged on the background icon. In step 104, an audio feature amount is selected. In step 105, an audio icon is superimposed on the icon obtained in step 103.

Note that a basic icon is registered for each feature amount. For example, in step 103, by applying to the basic icon a deformation algorithm corresponding to the value or variance of a feature amount, the value of the feature amount can be reflected on icon display in various embodiments, so that the actual value or variance of the feature amount can be recognized by the user.

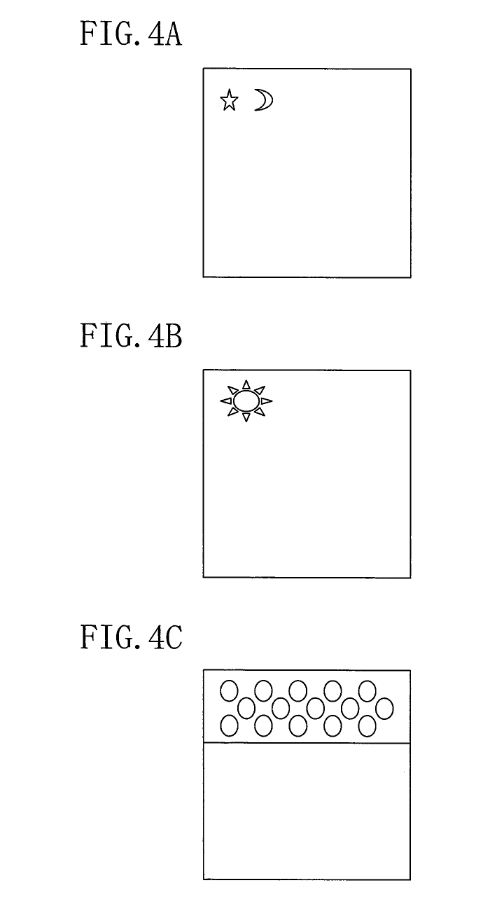

FIGS. 4A, 4B and 4C show exemplary background icons. FIG. 4A represents video at nighttime, and FIG. 4B represents video at daytime. The icon of FIG. 4C is a combination of a lower-half portion reflecting the color of a ground (earth or lawn) and an upper-half portion indicating the presence of spectators. According to the example of FIG. 4C, a plurality of single icons are combined to generate a single icon, thereby systematically creating various feature amount icons.

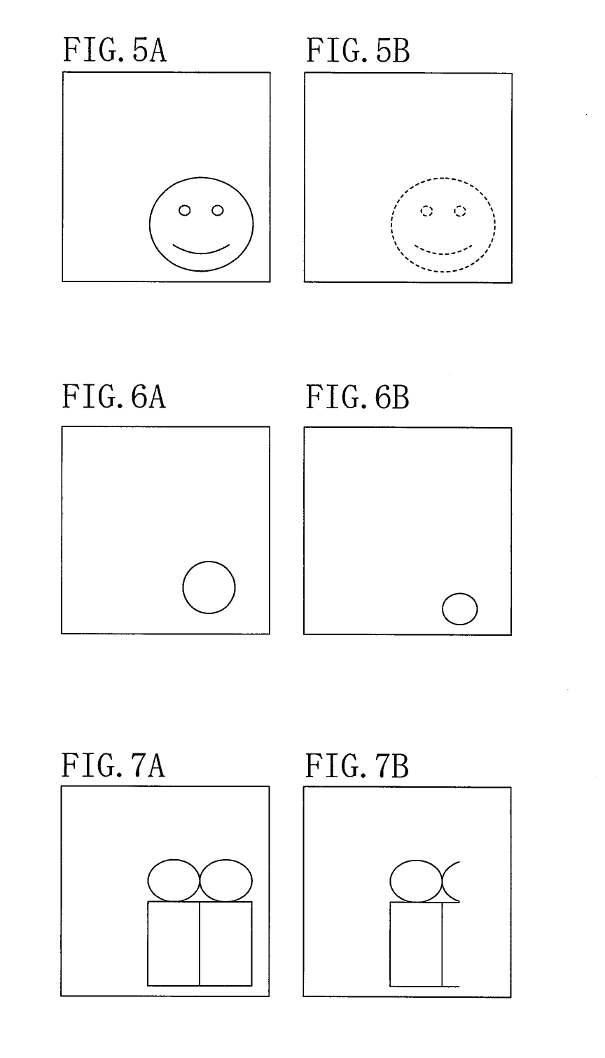

FIGS. 5A and 5B show an exemplary foreground icon and its exemplary deformation. It is here assumed that something like a human face is recognized. In this case, although it is desirable that a human face can be clearly recognized, it is generally difficult to perform perfect image recognition, so that errors often occur. Therefore, the transparency can be changed, depending on the accuracy level, as shown in FIG. 5B. When the transparency is low, the user can be clearly informed that there is something looking like a human face, but not definitely. By changing the density of the icon, the accuracy of corresponding information can be represented. Another effective method is to blur the icon. This is achieved by filtering. For example, by changing the intensity of a filter for smoothing, the blurring effect can be obtained. Various corresponding parameters can be effectively represented by filtering. Also, the size of an object whose feature amount has been successfully recognized may be changed.

FIGS. 6A and 6B show another exemplary foreground icon and its exemplary deformation, where the size of a ball is recognized. Ball game events can be distinguished from each other to some extent based on the ball size, and therefore, this information is effective. In this case, by changing the size of an icon figure, the size of a corresponding object can be intuitively represented.

FIGS. 7A and 7B show a still another foreground icon and its exemplary deformation. In the case of a parameter indicating the number of people, as shown in FIGS. 7A and 7B, a basic icon may be deformed so that a portion thereof becomes transparent and the size of the transparent portion is changed. In other words, by causing a portion of an icon to be transparent, a corresponding feature can be quantitatively represented.

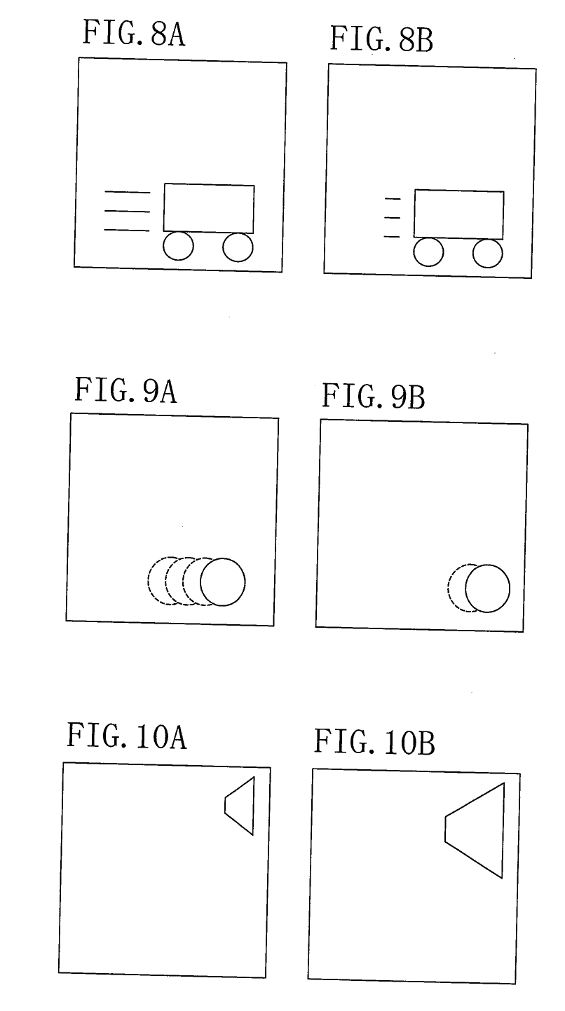

FIGS. 8A and 8B show exemplary foreground icons representing motions. Here, the speed of a moving train is represented by the lengths of lines. By representing a motion using lines, the intensity of the motion can be intuitively recognized.

FIGS. 9A and 9B show other exemplary foreground icons representing motions. Here, the speed of a ball is represented by overlaying balls one on another. By overlaying figures one on another to represent a motion, the intensity of the motion can be represented.

FIGS. 10A and 10B show exemplary audio icons. These examples represent the loudness of sounds using the sizes of loudspeakers. Audio data can also be used.

FIG. 11 shows an exemplary foreground icon representing a variance of motions. This is an exemplary representation when motions vary in a plurality of pieces of moving image data. When an image of a slow train and an image of a fast train coexist, the lengths of lines can be varied as shown in FIG. 11. Thereby, the user can recognize that the icon represents that the speed varies to some extent.

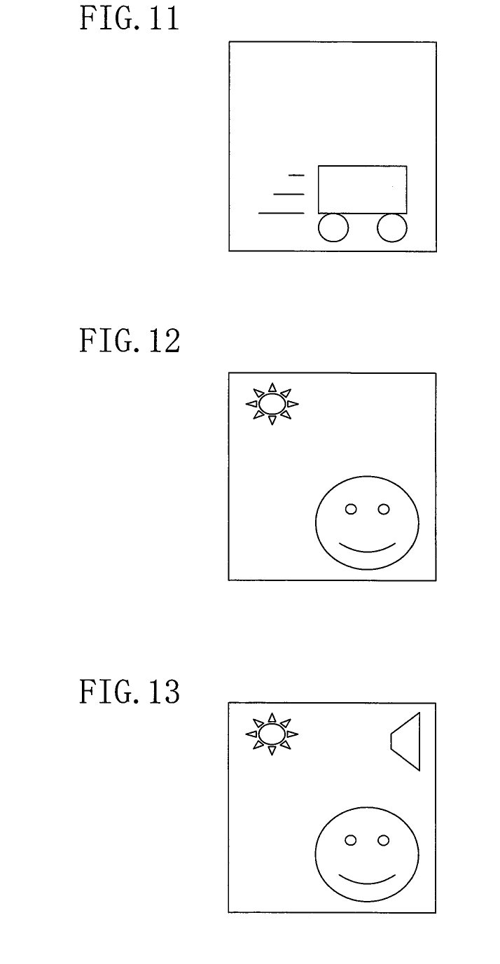

FIG. 12 shows an example in which a foreground icon is superimposed on a background icon. As described above, a feature of a background and a feature of a foreground are separated from each other, icons are separately generated for these features, and the foreground icon is superimposed on the background icon.

FIG. 13 shows an example in which a foreground icon and an audio icon are superimposed on a background icon. By superimposed an icon indicating a feature of sound on the image feature amount icon of FIG. 12, the image feature and the sound feature can be easily represented in combination.

As described above, various visual representations can be used to cause the user to strongly imagine feature amounts. This large number of variations is the merit of generation of icons from feature amounts. If only predetermined icons are displayed, such a large number of variations cannot be represented.

Next, moving image retrieval in which the effect of the present invention is most significantly exhibited will be described.

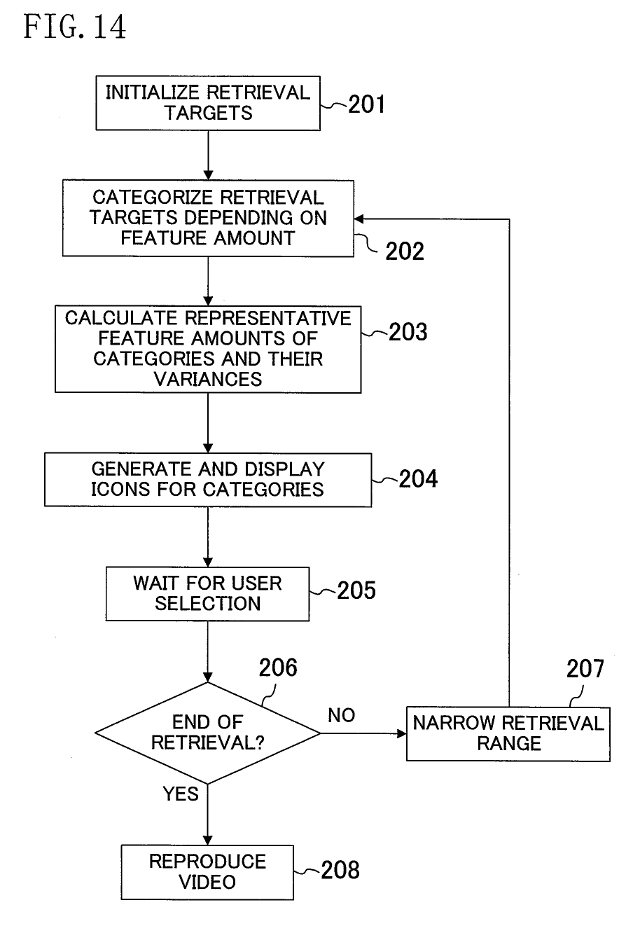

FIG. 14 is a flowchart of video data retrieval in the video data recorder 10 of FIG. 1. Initially, in step 201, targets to be retrieved are initialized with respect to video data in the hard disk 11 or on a disc loaded in the DVD drive 30. All files may be initially set as retrieval targets. Note that a specific moving image file (e.g., a duplicate) may be excluded from retrieval targets as described below regarding an edit operation.

Next, in step 202, distributions of feature amounts of retrieval target files are examined, and the retrieval targets are divided into a plurality of groups. It is here expected that feature amount distributions are mostly biased, depending on the feature of moving image files. For example, files are divided into those having considerably large specific feature amounts and those having considerably small specific feature amounts. In other words, a larger number of such feature amounts is more suitable for categorization. Such feature amounts are used to divide all files into a plurality of groups in step 202. As described below, the categories are displayed as a menu, and therefore, files are divided into only a number of categories appropriate for displaying and selection. Note that it depends on the user's preference, and the number of categories may be determined by the user to be, for example, 10. In step 203, representative feature amounts are calculated for the respective categories, and their variances are calculated.

In step 204, an icon is generated and displayed for each category. In this case, as shown in FIG. 11, the icon is deformed, depending on the distribution of feature amounts of video data to be retrieved, so that the feature amount distribution can be presented to the user. Thereby, a retrieval menu can be provided based on categorization optimal to retrieval targets. Also, if a feature amount indicating a smallest variance is used for icon generation with priority, a retrieval icon reflecting the variance can be generated.

In step 205, the process waits for selection by the user. In step 206, it is determined whether or not retrieval is ended. If retrieval continues, the retrieval range is narrowed, depending on the selected icon, in step 207, and thereafter, the process returns to step 202. More detailed retrieval operations are performed while icons corresponding to sub-categories are generated.

The above-described process can be repeated until the selection range becomes small. Since icons optimal to each selection range are displayed, it is highly convenient. When the number of choices is small, the user may select desired video.

When retrieval is ended, a retrieved moving image(s) or still image(s) is reproduced and displayed in step 208. In this case, if there are a plurality of retrieved moving images or still images, they may be successively displayed. Also, when a feature amount represents a specific scene in a single moving image, only the matching scene may be displayed.

Note that groups selected by icon selection are desirably the same as groups which are obtained by categorization during menu generation. This is because icon selection can match the contents of retrieval. However, the evaluation of image recognition generally varies depending on subjective recognition by the user. Therefore, if groups selected by icon selection are caused to accurately match groups which are obtained by categorization during menu generation, an image desired by the user may often fail to be included in icons. Therefore, it is more desirable to select data having a feature amount within a range slightly larger than the feature amount range which is used for categorization during menu generation. Thereby, the possibility of retrieval omission during icon selection can be reduced.

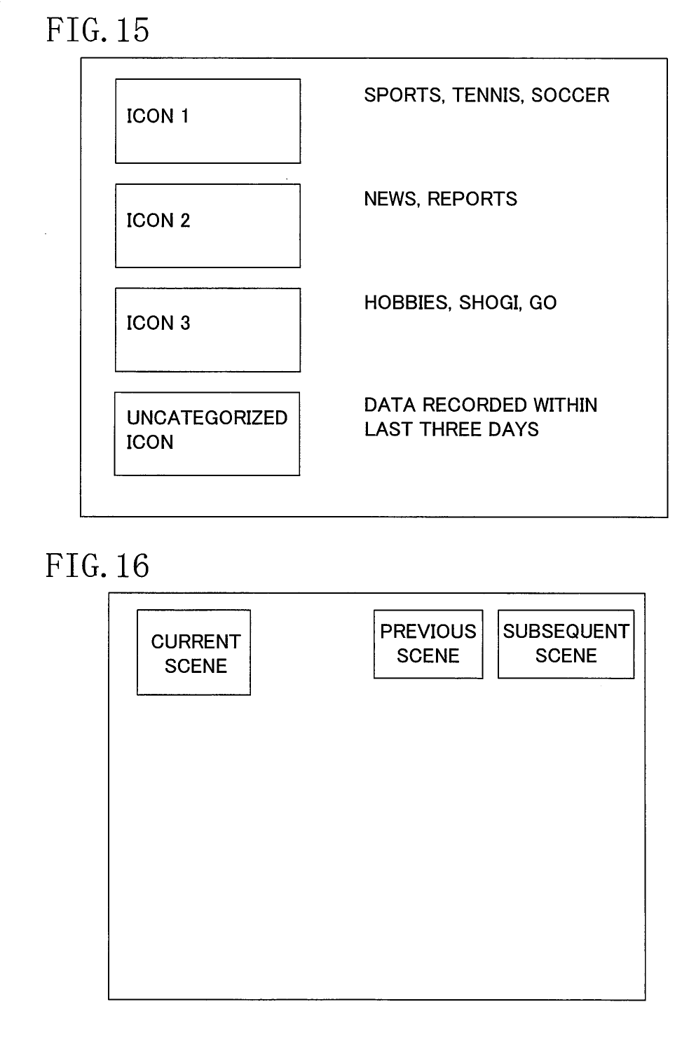

FIG. 15 shows an exemplary retrieval menu screen of the video data recorder 10 of FIG. 1. Here, first, second and third icons and an uncategorized icon are displayed. For example, the first to third icons correspond to three categories obtained by feature amount extraction, and the uncategorized icon is a special icon which represents data and for which feature amount extraction has not been completed and which, for example, has been recorded within the last three days. The first icon represents sports contents, such as tennis, soccer and the like, which have intense motions as a feature. The second icon represents contents, such as news programs, reports programs and the like, which have mild motions and in which a single person is present at a center. The third icon represents contents of hobbies, such as shogi, go and the like, whose background contains large-size pieces and board. A keyword display based on meta-data is added to each icon, so that the easiness of retrieval is improved.

Although the icon of the present invention does not require a keyword, a keyword is considered to assist conveying an image to the user. Therefore, if a keyword is present at the same time when an icon is generated, the keyword can also be displayed. However, it may be expected that there are considerably many keywords to be assigned to a single icon. In an extreme case, the same keyword may be displayed for all icons, which is meaningless.

Therefore, the priority of a keyword to be displayed is determined using the frequency of occurrence. Specifically, a keyword that frequently appears in data belonging to one icon and does not appear in data belonging to the other icons, is given a higher priority. By performing such a process, an appropriate keyword is displayed as required. Any meta-data, such as other video data and the like, as well as keywords can be supported. Also, if an appropriate keyword is not found, no keyword needs to be displayed.

There are two methods of processing video data that has not yet been associated as index information in the feature amount index control section 17. One method is to associate all search patterns with data that has not yet been assigned. According to this method, data which has not yet been assigned does not fail to be retrieved. The user can certainly find desired data. The other method is to utilize the fact that data which has not yet been assigned is data which was most recently added, additionally display an icon indicating most recent data (the uncategorized icon of FIG. 15), and cause the user to make choice. Since there are few images whose feature amounts have not yet been calculated, the process does not necessarily need to wait until all feature amounts have been extracted.

As described above, the video data recorder 10 of this embodiment exhibits a considerably significant effect in retrieval of recorded moving images. Also, video data on a DVD as well as video data recorded in the hard disk 11 can be easily retrieved if index information is created for the video data in the DVD.

The method of using the icon of the present invention is not limited to image retrieval as described above. For example, it is more preferable to provide a technique of causing the user to be further accustomed to using icons for retrieval so as to cause the icon to be more easily used.

FIG. 16 shows an exemplary normal reproduction screen of the video data recorder 10 of FIG. 1. For example, an icon reflecting a feature amount of a currently displayed scene is displayed at an upper left corner of the screen. In addition, an icon corresponding to a previous scene and an icon corresponding to a subsequent scene are presented as a menu to the user. By selecting these icons, the current scene can be changed to the previous and subsequent scenes. If icons are displayed during normal reproduction in the above-described manner, the user can further understand the correspondence between the images and the icons, resulting in the effect of increasing the convenience of icons during retrieval.

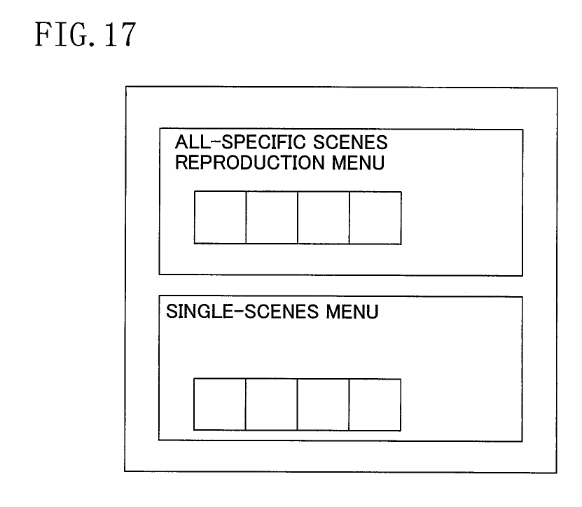

FIG. 17 shows an exemplary moving image reproduction menu screen of the video data recorder 10 of FIG. 1. A “single-scenes menu” shown in a lower-half portion of FIG. 17 contains a plurality of icons each reflecting a feature amount of a corresponding scene, which has a function similar to that of a scene selection menu during conventional DVD reproduction. On the other hand, according to a new menu shown in an upper-half portion of FIG. 17, i.e., “all-specific scenes reproduction menu”, icons representing feature amounts are arranged, and only scenes having feature amounts close to an icon selected by the user are joined together and are reproduced. By reproducing scenes corresponding to menu selection, only scenes having a specific feature amount can be reproduced. For example, scenes in which a specific person appears can be reproduced.

The new menu of FIG. 17 is generated by the menu generation section 20 of FIG. 1. The new menu can be dubbed using the DVD drive 30 so that it can be used as a DVD menu. Thereby, the menu of the present invention in which a feature amount of video data is utilized can be implemented in other DVD recorders. Also, only scenes having a specific feature amount can be easily dubbed. Thereby, moving image data including only desired extracted scenes can be efficiently created.

Also, video can be easily edited if an icon is provided for each scene. Video editing involves a scene retrieval operation. If the icon of the present invention is used for scene retrieval, the convenience of editing is improved.

For example, when video data is transferred to other apparatuses, the format of recorded video data may be changed to a format which allows the video data to be reproduced in other apparatuses. When the hard disk 11 nearly overflows, data may be compressed again. In these cases, it is considered that even if the encoded format is changed, the feature amount of an image does not change. Therefore, the feature amount of the data does not need to be calculated again. Therefore, when such duplication is performed, it is recorded what is the original data of the duplicate. Specifically, when data is duplicated, a feature amount of the duplicate is associated with the original feature amount, so that the feature amount does not need to be calculated during data duplication.

Here, attention should be paid to a case where original data is deleted. In this case, original video data is erased, and corresponding feature amount data may be desired to be deleted. However, in such a case, feature amount information corresponding to duplicated video data is erased. Therefore, most desirably, when video data is deleted, the feature amount information of the video data is correctly associated with the duplicated video data.

Note that, in the case of moving image retrieval in which a feature amount of video data is used as described above, the same video pieces should be considered as a single piece of video. Therefore, duplicates for which the original image is present are previously excluded from retrieval targets. It is considered that some duplicates have degraded image quality, and it is desirable to use original data. In other words, if duplicated video data is excluded from retrieval targets, the possibility that original data having higher image quality than that of duplicated video data is retrieval can be improved.

As described above, the video data management apparatus of the present invention generates an icon from a feature amount of video data, and this icon can be used for retrieval. Also, when the icon is used during normal reproduction and the like, the correspondence between the icon and the video can be presented to the user in an easily recognizable manner, resulting in moving image retrieval that can be considerably easily used.

Therefore, the video data management apparatus of the present invention is particularly effective to moving image retrieval that can be easily understood by the user, in a video recording/reproduction apparatus.

What is claimed is:

1. A video data management apparatus comprising:
a feature amount information calculating means for calculating feature amount information of video data; and
an icon presenting means for generating an icon reflecting the feature amount information of the video data and presenting the icon to a user.

2. The video data management apparatus of claim 1, wherein
the icon presenting means generates the icon by combining a plurality of basic single icons each generated using a portion of the feature amount information.

3. The video data management apparatus of claim 2, wherein
the icon presenting means superimposes a foreground icon on a background icon.

4. The video data management apparatus of claim 2, wherein
the icon presenting means performs a deformation process with respect to the basic single icon in accordance with the feature amount information.

5. The video data management apparatus of claim 4, wherein
the icon presenting means changes the density of the basic single icon, depending on the accuracy.

6. The video data management apparatus of claim 4, wherein
the icon presenting means performs a filtering process with respect to the basic single icon in accordance with the feature amount information.

7. The video data management apparatus of claim 4, wherein
the icon presenting means changes a size of the basic single icon, depending on a size of a corresponding object.

8. The video data management apparatus of claim 4, wherein
the icon presenting means causes a portion of the basic single icon to be transparent in accordance with the feature amount information.

9. The video data management apparatus of claim 4, wherein
the icon presenting means provides a visual effect of representing a motion to the basic single icon in accordance with feature amount information representing the intensity of a motion.

10. The video data management apparatus of claim 9, wherein
the icon presenting means provides a line or lines representing a motion, as the visual effect, to a side of the basic single icon.

11. The video data management apparatus of claim 9, wherein
the icon presenting means arranges the plurality of basic single icons so that they overlap each other, as the visual effect.

12. The video data management apparatus of claim 2, wherein
the icon presenting means superimposes an audio icon representing a feature of sound on the icon reflecting the feature amount information of the video data.

13. The video data management apparatus of claim 1, further comprising:
an index information recording means for recording the feature amount information and the video data in association with each other, as index information,
wherein, when feature amount information required by the icon presenting means is not contained in the index information recorded in the index information recording means, new video data feature amount information is calculated by the feature amount information calculating means and is used, and
when feature amount information required by the icon presenting means is contained in the index information recorded in the index information recording means, the feature amount information recorded in the index information recording means is used.

14. A video data management apparatus comprising:
a feature amount information calculating means for calculating feature amount information of video data;
an icon generating means for generating a plurality of icons each reflecting the feature amount information of the video data;
a displaying means for displaying the plurality of generated icons;
a selecting means for selecting one of the plurality of displayed icons; and
a retrieving means for retrieving and presenting video data corresponding to the selected icon to a user.

15. The video data management apparatus of claim 14, further comprising:
an index information recording means for recording the feature amount information and the video data in association with each other, as index information,
wherein the retrieving means retrieves the video data corresponding to the selected icon using the feature amount information recorded in the index information recording means.

16. The video data management apparatus of claim 15, wherein
the displaying means has a function of displaying a special icon which is not associated with any feature amount information, and
the retrieving means, when the special icon is selected, retrieves video data for which correspondence is not recorded in the index information recording means.

17. The video data management apparatus of claim 14, further comprising:
a categorizing means for dividing video data to be retrieved into a plurality of groups each having similar feature amount information; and
a representative feature amount information calculating means for calculating representative feature amount information of each group categorized by the categorizing means,
wherein the icon generating means generates an icon reflecting the group representative feature amount information.

18. The video data management apparatus of claim 17, wherein
the icon generating means performs a deformation process with respect to the group icon in accordance with a distribution of feature amount information of a plurality of pieces of video data belonging to a group.

19. The video data management apparatus of claim 17, wherein
the representative feature amount information calculating means uses feature amount information indicating a smallest variance of pieces of feature amount information of a plurality of pieces of video data belonging to a group, with priority, to calculate the representative feature amount information.

20. The video data management apparatus of claim 14, further comprising:
a meta-data recording means for recording a relationship between video data and meta-data,
wherein the displaying means obtains meta-data corresponding to the icon from the meta-data recording means and displays the meta-data together with the icon.

21. The video data management apparatus of claim 20, wherein
the displaying means displays, of the meta-data, one that is contained in video data presented when a corresponding icon is selected and is not contained when other icons are selected, with priority.

22. The video data management apparatus of claim 21, wherein
the meta-data is a keyword.

23. The video data management apparatus of claim 15, wherein
when feature amount information required by the icon generating means is not contained in the index information recorded in the index information recording means, new video data feature amount information is calculated by the feature amount information calculating means and is used.

24. The video data management apparatus of claim 23, wherein
the feature amount information calculating means includes:
a decoding means for decoding encoded video data; and
an extracting means for extracting feature amount information from a result of the decoding means.

25. The video data management apparatus of claim 24, wherein
the decoding means of the feature amount information calculating means is also used for reproduction of the encoded video data.

26. The video data management apparatus of claim 24, wherein
the decoding means changes decoding algorithms, depending on the feature amount information required by the extracting means.

27. The video data management apparatus of claim 23, wherein
the feature amount information calculating means calculates, with respect to video data encoded using a motion vector, feature amount information indicating the intensity of a motion using the motion vector.

28. The video data management apparatus of claim 15, further comprising:
a duplicating means for duplicating video data,
wherein the index information recording means associates the duplicated video data with the same feature amount information as that of original video data thereof.

29. The video data management apparatus of claim 14, wherein
duplicated video data are not a target to be retrieval by the retrieving means.

30. A video data management apparatus comprising:
an icon generating means for generating an icon reflecting feature amount information of video data; and
a displaying means for combining and displaying the generated icon and the video data corresponding to the icon.

31. A video data management apparatus comprising:
an icon generating means for generating a plurality of icons each reflecting feature amount information of a scene in moving image data;
a displaying means for displaying the plurality of generated icons;
a selecting means for selecting one of the plurality of displayed icons; and
a reproducing means for reproducing only a scene or scenes corresponding to the selected icon.

32. A video data management apparatus comprising:
an icon generating means for generating an icon reflecting feature amount information of a scene previous or subsequent to a currently reproduced scene, during reproduction of moving image data;
a displaying means for combining and displaying the currently reproduced scene and the generated icon;
a selecting means for selecting the displayed icon; and
a controlling means for performing a control in response to selection of the icon so that the scene is changed to the scene corresponding to the icon.

33. A video data management apparatus comprising:
an icon generating means for generating a plurality of icons each reflecting feature amount information of a scene in moving image data;
a menu data generating means for generating scene selection menu data using the generated icons; and
a reproduction data generating means for generating moving image reproduction data in which the moving image data is associated with the menu data.

34. A video data management apparatus comprising:
an icon generating means for generating a plurality of icons each reflecting feature amount information of a scene in moving image data;
a displaying means for displaying the plurality of generated icons;
a selecting means for selecting one of the plurality of displayed icons; and
a moving image data generating means for generating moving image data including only a scene or scenes having feature amount information close to that of the selected icon.
